(19) United States
(12) Patent Application Publication
(10) Pub. No.: US 2016/0082522 A1
(43) Pub. Date: Mar. 24, 2016

(54) MATERIAL-REMOVING MACHINE TOOL, TOOL SET AND METHOD FOR PRODUCING A CYLINDER HAVING A BLIND AND/OR STEPPED BORE

(71) Applicant: ECOROLL AG WERKZEUGTECHNIK, Celle (DE)

(72) Inventor: Alfred OSTERTAG, Celle (DE)

(73) Assignee: ECOROLL AG WERKZEUGTECHNIK, Celle (DE)

(21) Appl. No.: 14/787,007

(22) PCT Filed: May 14, 2014
(86) PCT No.: PCT/EP2014/001302

§ 371 Date: Oct. 26, 2015

(30) Foreign Application Priority Data
May 17, 2013 (DE) 10 2013 209 243.1

(51) Int. Cl. B23B 41/02; B23B 31/11; B23B 31/00; B23B 47/34; B23B 29/034

(52) U.S. Cl. CPC B23B 41/02; B23B 47/34; B23B 29/03432; B23B 31/008; B23B 31/11; B23B 2215/24; B23B 2270/025; B23B 2270/24; B23B 2270/26

(57) ABSTRACT

The invention relates to a material-removing machine tool, in particular a deep-hole drilling machine or lathe, having a workpiece holder (14) to holding a workpiece (30), a tool holder (16), a rotary drive (18), by means of which the tool holder (16) can be rotated relative to the workpiece holder (14), an adapter (20) which has a base (20) which is rotationally fixedly connected to the tool holder (16) and has a drive side facing the tool holder (16) and an output side facing away from the tool holder (16), an anti-rotation device (42) for preventing drill head (22) and adapter (20) from rotating relative to each other and a central, continuous channel (44), through which chips can be transported away counter to a machining direction (B) of the drill head (22), and a drill head (22) which is rotationally fixedly connected to the adapter (20). According to the invention, the drill head (22) has a drill head thread (48) and a tapered shaft (50), and the adapter (20) has a union nut (34) which is rotatably fixed to the base (20) and an adapter thread (36) to interact with the drill head thread (48), and a tapered bore (38) to receive the tapered shaft (50).

The invention relates to a material-removing machine tool according to the preamble of claim 1. According to a second aspect, the invention refers to a tool set. According to a third aspect, the invention relates to a method for production of a cylinder with a blind and/or stepped bore, particularly a deep-hole drilling method.

The production of cylinders usually requires at least three work steps, i.e. to drill out, skiving, and subsequent burnishing. This way, the high requirements to accurate form and surface needs of the cylinder's inner wall can be achieved.

The production of cylinders is particularly elaborate if they have a blind bore and/or a stepped bore. The reason for this is that the resulting chips must be transported away specifically when drilling out. This is only possible through the tool in a blind bore. To subsequently skive and burnish the cylinder's inner wall, at least another tool is needed, which requires a high fluid pressure, i.e. either for folding in and out of the skiving knives and/or to charge the rollers with pressure. This tool change is difficult because of the different requirements of the individual tools.

Specifically in production of larger lots, it has therefore become established to first drill out all workpieces, then to install the skiving tool and to perform the skiving treatment for all workpieces of the lot. The detrimental part of this procedure is that the re-clamping makes it difficult to achieve highest accuracies and that re-clamping is also high effort.

From DE 10 2010 013 480 A1, a material-removing machine tool is known in which the drilling head is connected to a drilling tube with a tool carrier. A direction control permits active influence on the processing direction during processing, increasing the achievable accuracy specifically in production of eccentric inner tube structures.

From DE 10 2011 110 044 B4, a method for producing a cylinder unit is known, with which the cylinder and the front can be processed in one clamp. To make do without additional components to switch the skiving knives used for skiving, the skiving knives can be switched with the cooling lubricant used for material removal.

From EP 048 578 A2, a tool holder is known that has a conical bore with which a truncated cone-shaped shaft of a tool can be fastened. The shaft is attached to the tool holder with a union nut tool holder. This kind of tool holder is not suitable for drilling open cylinders, since the transporting away of chips is not ensured.

From WO 2014/011 198 A1, a deep-drilling machine is known that has an adapter. The adapter permits a deep-drilling machine to drill open, skive and burnish non-continuous cylinders in one clamp. The skiving knives can be charged with pressure fluid by a central pressure line and thus switched. This deep-drilling machine has the disadvantaged of not being able to produce blind holes.

The invention is based on the task of improving the production of cylinders with blind and/or stepped bores.

The invention solves the problem with a machine tool with the characteristics of claim 1. According to a second aspect, the invention solves the problem by a tool set according to the secondary claim. According to a third aspect, the invention solves the problem by a method with the characteristics of the method claim.

The advantage of the invention is that even present material-removing machine tools, such as lathes or deep-drilling machines, can be upgraded for automatic tool change.

Another advantage is that the risk of damaging one of the threads involved during tool change and thus rendering the entire tool useless is much reduced. The tapered bore and the anti-rotation device make it possible to not completely bring the drill head into contact with the adapter axially flush, without endangering a thread by this. The drill head can be then aligned flush with the adapter by pushing it into the adapter. When this has been achieved, the drill head is firmly connected to the adapter with the union nut.

The adapter according to the invention permits, depending on tool type, machine type and processing task, to discharge essentially pressure-free cooling lubricant with chips, providing hydraulic pressure to control a skiving tool or cooling lubricant with a pressure of more than 40 bar for cooling the blades and material removal as well as concurrent tool control.

In the scope of this description, the material-removing machine tool may be a deep-drilling machine. A deep-drilling machine specifically is a device constructed to drill holes with an aspect ratio of at least 10 in workpieces of metal. The aspect ratio is the quotient of length of the bore and its diameter. Such deep-drilling machines are special machines, since deep drilling must be performed with a sufficient accuracy so that specifically hydraulic cylinders can be produced.

The drill head is a unit that can be separated from the adapter and the tool holder, on which a blade or several blades are formed with which the cylinder inner face of the resulting cylinder is processed. The anti-rotation device is specifically a device that prevents a twist between the adapter and drill head in at least one direction. However, it is particularly beneficial if the anti-rotation device prevents twisting of the drill head and adapter relative to each other in both rotating directions. For example, the anti-rotation device comprises a fitted key or a fitted pin.

The term of torque-proof means that a torque can be transmitted in at least one rotating direction from the one object, in this case the tool holder, to the other object, in this case the base. It is possible, but not necessary, that a torque can be transmitted in both directions.

According to a preferred embodiment, the adapter has a base to which the union nut is attached, and a ring element that is placed between a front face of a tapered shaft and the base so that the central channel for the machining direction of the drill head is free of undercuts. This ring element is preferably made of a material that is more elastic than the material of which the base and/or the tapered shaft of the drill head are made.

This way, the ring element will deform more easily than the adapter or the drill head, and their fitting accuracy relative to each other is not influenced by the ring element.

The characteristic that the central channel is undercut-free at least regarding the machining direction of the drill head between the front face and an opposite face of the adapter, specifically means that an imagined ball with a diameter of 1 mm, when moving in the machining direction of the drill head from the input side to the output side along the inner wall of the adapter and drill head, will at no point be moved radially outwards by more than 1 mm. In reverse, this means that chips that flow from the drill head onto the input side will not be subjected to any radially inward pointing edge where they could catch. This ensures optimised chip flow.

According to one preferred embodiment, the material-removing machine tool in the form of a CNC-lathe has a pressurised fluid line that runs through the central channel, and a drill head cooling lubricant line that is connected to the adapter cooling lubricant line and that has an opening at a radially outer face of the drill head, so that cooling lubricant from the adapter-cooling lubricant line can be supplied to a space between the drill head and an inner wall of the workpiece. Both cooling lubricant lines are specifically formed for conducting cooling lubricant with a pressure of at least 50 bar.

It is particularly beneficial when the material-removing tool also comprises a skiving tool that can be connected positive-lockingly to the adapter as an alternative for the drill head, with the skiving tool comprising a tapered shaft for form-locking connection of the tapered bore of the adapter and a skiving tool-cooling lubricant line that is formed so that it can be connected to the adapter-cooling lubricant line and an opening at a radially outer face of the skiving too, so that cooling lubricant from the adapter-cooling lubricant line can be supplied to the space between the skiving tool and the inner wall of the workpiece.

It is of particular advantage when the drill head, the skiving tool and the burnishing tool are provided in a tool magazine that can be actuated automatically, which can be controlled from a machine control of the material-removing machine tool. Particularly preferentially, the material-removing machine tool comprises an automatically controllable gripper unit comprising a gripper that is formed for positive-locking connection to the union nut, so that the connection between adapter and drilling head can be released and/or produced automatically. The positive-locking connection can be achieved, e.g. by interlocking of the gripper in a recess of the drill head and/or interlocking of the protrusion of the union nut with a recess of the gripper. Of course, a friction-locking connection is generally imaginable as well, even though these can usually transmit only lower torques.

It is of particular advantage if the material-removing machine tool also comprises a rolling tool that can be connected positive-lockingly to the adapter as an alternative for the drill head, and a tapered shaft for a positive-locking connection to the tapered bore of the adapter and a rolling tool-cooling lubricant line that is formed connectable to the adapter-cooling lubricant line and that comprises an opening at a radially outer face of the burnishing tools, so that cooling lubricant from the adapter-cooling lubricant line can be supplied to a space between the burnishing tool and an inner wall of the workpiece. This burnishing tool can be used for final processing of a cylinder.

Due to the presence of the tapered shaft and tapered bore with anti-rotation device, it is possible to provide for an automatic gripper, since the accuracies achievable with grippers usually are not sufficient to screw a thread directly. The construction of the adapter, however, leads to an increased alignment tolerance of the system, so that the accuracy that can easily be achieved with an automatic gripper is sufficient to connect the tools to the adapter and loosen them from it.

It is of particular advantage if the gripper if formed turning relative to a holder of the gripper. A particularly simple setup results when the rotation between gripper and holder can be achieved by a cylinder, specifically a hydraulic cylinder. This cylinder can then be charged with pressure fluid, specifically cooling lubricant, and a hydraulic fluid that can also be used to actuate the skiving knives of the skiving tool.

Preferably, the adapter, in particular the union nut, and the respective tool are formed so that the die union nut can be moved from the locking position in which the drill head is positive-lockingly connected to the adapter, into a release position, in which the drill head can be moved in the axial direction relative to the adapter by turning it by no more than 90°, specifically no more than 80°. This movement can be performed by the gripper relative to its holder by actuating a drive cylinder, that the gripper can be easily controlled.

Preferably, the adapter has an output valve on the output side that comprises an output valve body that can opens the output valve by movement toward the input side. It is beneficial when the drill head, the skiving tool and/or the fixed roller tool comprise a handover valve that comprises a handover valve body that closes the handover valve by movement in the axial direction away from the adapter. This prevents the fluid, specifically cooling lubricant and/or pressure fluid from escaping at disconnection.

According to a preferred embodiment, the adapter has a central pressurised fluid line, placed in the central channel and connected to a pressure fluid supply unit for charging with fluid pressure on the side towards the workpiece holder, so that the fluid pressure can be transferred from the input side to the output side.

The pressure fluid supply unit specifically comprises a cooling lubricant supply unit and/or a hydraulic fluid supply unit. The central pressurised fluid line permits, e.g., conducting hydraulic fluid to a skiving tool that is connected to the adapter. The fluid pressure of the hydraulic fluid permits retraction and/or extension of a skiving knife. In this case, the machine tool preferably has a cooling lubricant supply unit with which the cooling lubricant can be supplied to a space between the skiving tool and an inner wall of the workpiece.

Preferably, the tool holder is formed hollow, so that a channel is formed. It is beneficial when the channel is connected to the pressure fluid supply unit so that pressure fluid can be routed through the tool holder in the form of cooling lubricant and/or pressure fluid in the form of hydraulic fluid. Alternatively or additionally, the tool holder is connected to the pressure fluid supply unit so that cooling lubricant from the central channel of the adapter can be routed through the tool holder to the cooling lubricant supply unit that cleans the cooling lubricant with a filter and routes it under pressure to the adapter and/or through a cooling lubricant line into the space between the skiving tool and an inner wall of the workpiece.

According to the invention a material-removing machine tool, specifically a deep-drilling machine or CNC-lathe, with (a) an adapter that (i) can be connected to a tool holder of a material-removing machine tool torque-proofly, and (ii) a union nut comprising an adapter-thread and (iii) a tapered bore, with the adapter comprising a input side facing towards the tool holder and an output side facing away from the tool holder, and a central, continuous channel, through which chips can be removed opposite a processing direction of the drilling-open tool, and with (b) a drill head, comprising (i) a drill head thread for form-locking interaction with the adapter thread and (ii) a tapered shaft for form-locking interaction with the tapered bore, with (c) the adapter comprising an adapter guiding surface and the drill head comprising a drill head guiding surface, which interact to prevent twisting of the drill head and adapter relative to each other, with (d) the tool set comprising a skiving tool, specifically a combined skiving-burnishing tool comprising a skiving tool guiding surface that is formed for interaction with the adapter guiding surface to prevent twisting of the skiving tool and adapter relative to each other.

The following explains the invention in more detail based on the enclosed drawings. Therefore

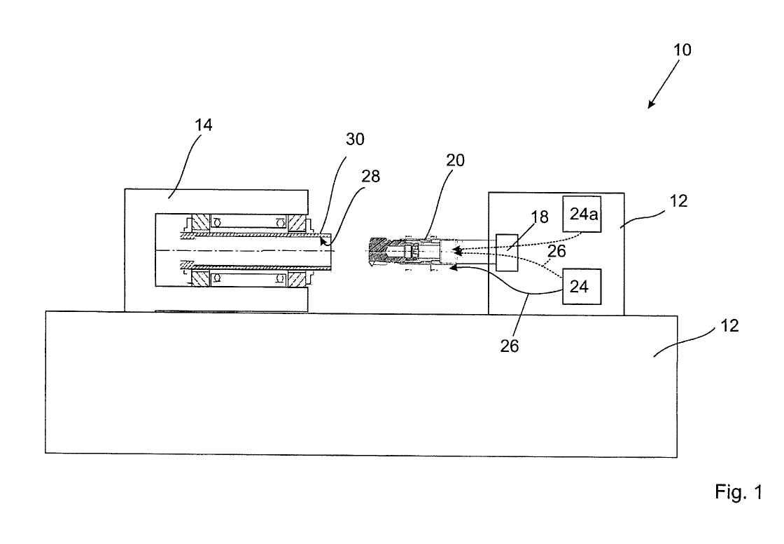

FIG. 1 shows a schematic view of a material-removing machine tool according to the invention,

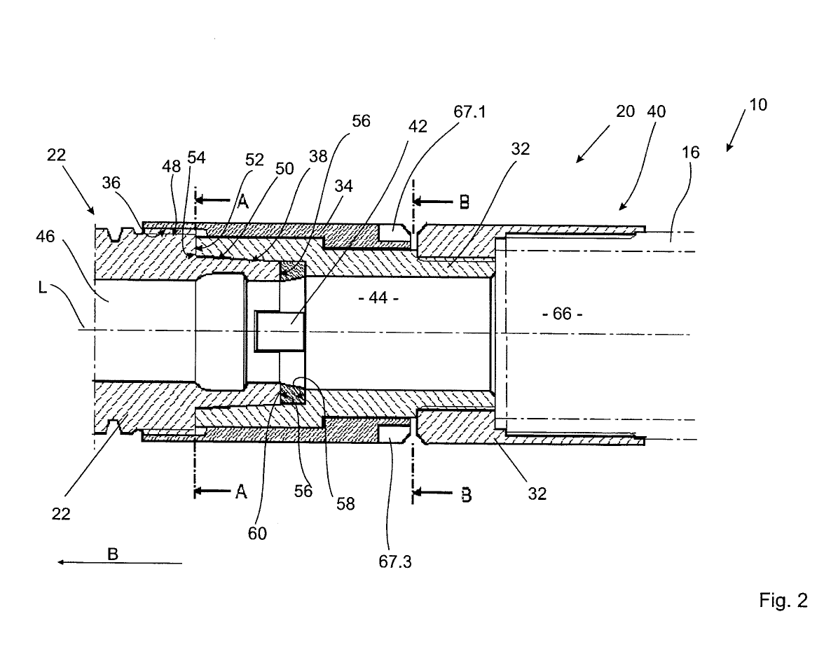

FIG. 2 shows an adapter of a tool set according to the invention and the machine tool pursuant to FIG. 1,

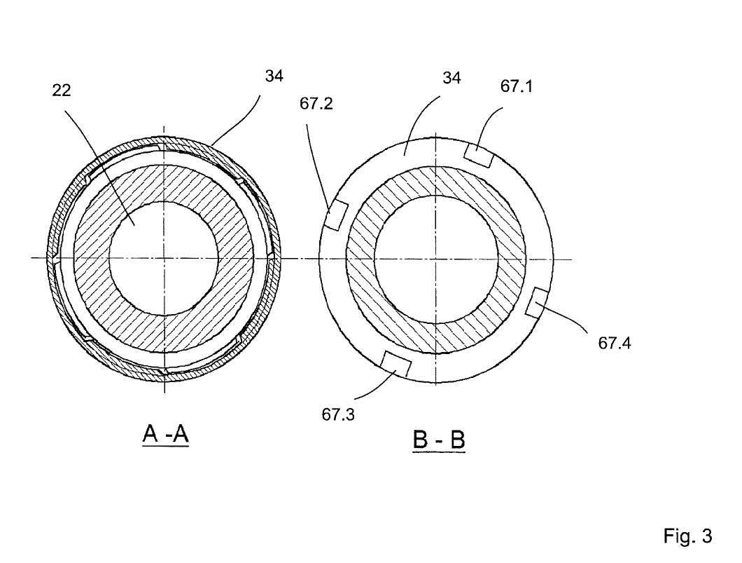

FIG. 3 shows two cross-sections pursuant to sections A-A and B-B through the adapter pursuant to FIG. 1,

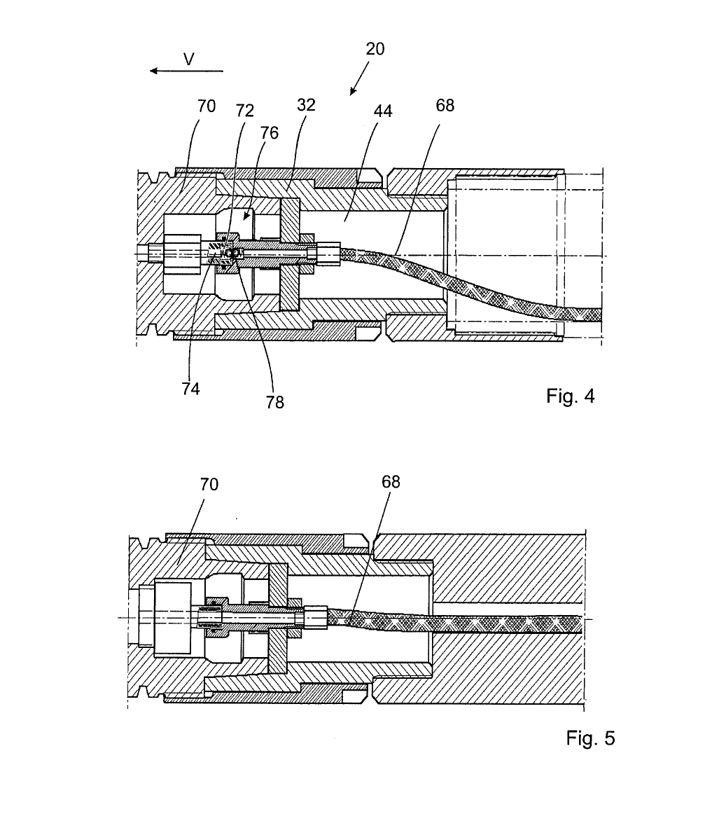

FIG. 4 shows the adapter pursuant to FIG. 1 with a pressurised fluid line contacting a skiving tool,

FIG. 5 shows an alternative embodiment of an adapter pursuant to FIG. 3,

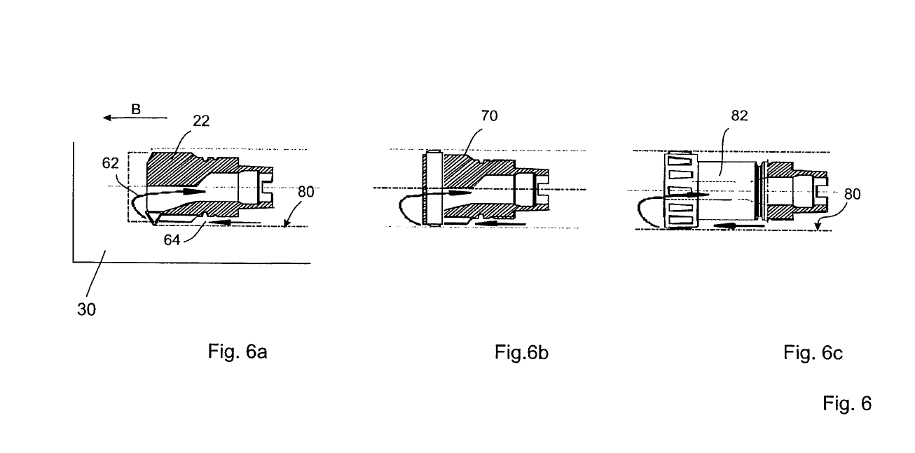

FIG. 6 shows a schematic view of a method according to the invention using a tool set according to the invention on a deep-drilling machine according to the invention,

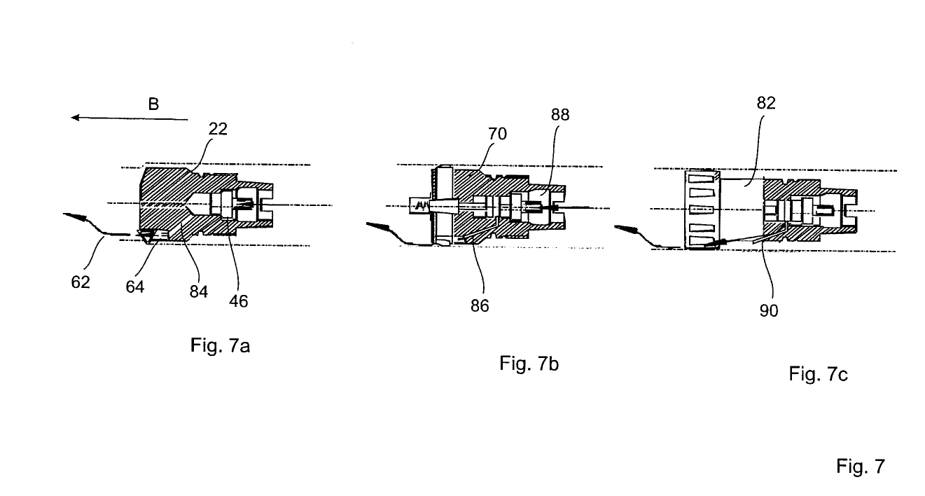

FIG. 7 shows a schematic view of a method according to the invention using a tool set according to the invention on a CNC-lathe according to the invention,

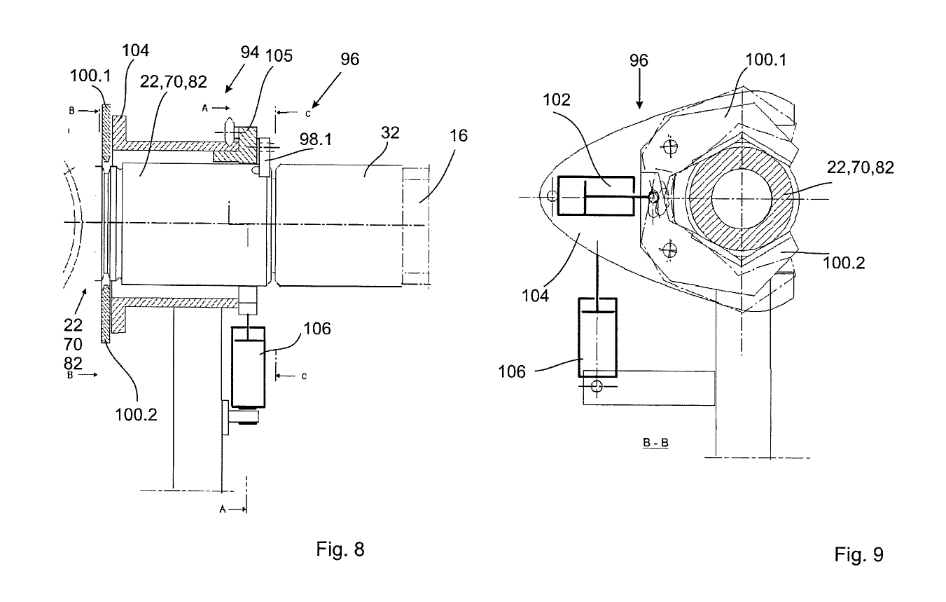

FIG. 8 shows a partial view of a machine tool according to the invention,

FIG. 9 shows a sectional view pursuant to section B-B,

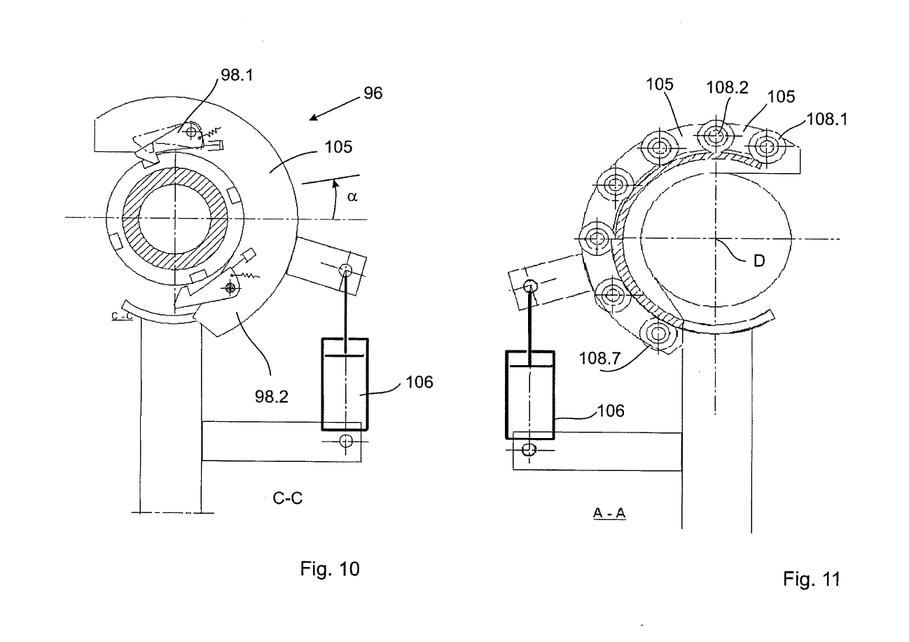

FIG. 10 shows a sectional view pursuant to section C-C pursuant to FIG. 7 and

FIG. 11 shows a sectional view pursuant to section A-A pursuant to FIG. 7.

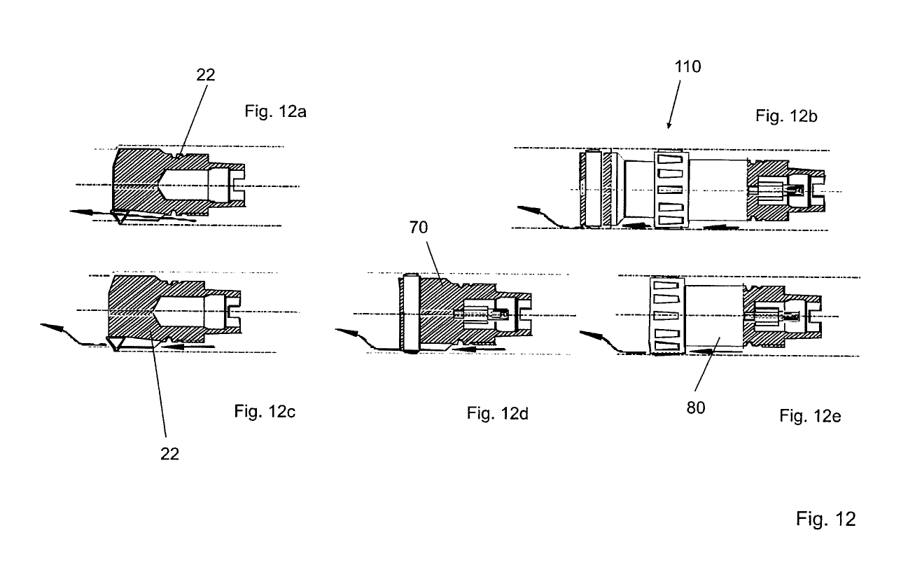

FIG. 12 shows the use of the adapter set when producing stepped bores (upper partial figures) and blind bores (lower partial figures) on deep-drilling machines.

FIG. 1 schematically shows a material-removing machine tool 10 in the form of a deep-drilling machine, comprising a machine bed 12, a workpiece holder 14 and a tool holder 16. The tool holder 16 can be turned relative to the workpiece holder 14 with a rotary drive 18, in this case formed by an electrical motor. Alternatively or additionally, it is possible that the workpiece holder 14 is rotatable. A relative motion between the workpiece holder and the tool holder is relevant. The machine tool 10 comprises an adapter 20, which is presented in more detail in the following figures, and a drill head 22 with a schematically drawn-in blade insert in the form of a cutting plate.

The machine tool 10 has a pressure fluid supply unit that comprises a cooling lubricant supply unit 24, through which cooling lubricant can be supplied via a cooling lubricant supply line 26 into a space 64 (see below, FIG. 6) between the drill head 22 and an inner wall 28 of a workpiece 30, and a hydraulic fluid supply unit 24a. The hydraulic fluids supply unit 24a can be connected by a pressurised fluid line (reference 68, see below) to a skiving tool to control its skiving blades, with the connection e.g. being made by the hollow tool holder 16.

The workpiece 30 is clamped in the workpiece holder 14. The workpiece holder 14 and tool holder 16 can be moved towards each other linearly guided by a motor. The corresponding guide and the drive motors or the drive motor are not drawn in, as they are part of prior art.

FIG. 2 shows a detail view of the adapter 20, which comprises a base 32. The base 32 is connected to the tool holder 16 torque-proofly, e.g. by a thread. The adapter 20 also comprises a union nut 34, which is attached rotatable to the base 32 and comprises an adapter thread 36.

The adapter 20 comprises a tapered bore 38, with this tapered bore specifically being a recess rotationally symmetric around a rotating axis L, the radius of which increases monotonously, specifically strictly monotonously, with increasing distance from a input side 40 of the adapter 22. Therefore, it is possible and preferred, but not necessary, that the inner contour of the tapered bore 38 is a truncated cone in the mathematic sense.

The adapter 20 also comprises an anti-rotation device 42, in this case comprising two tappets that are inserted into longitudinal grooves. In the adapter 20, a central, continuous channel 44 is formed that is connected to a drill head-channel 46 of the drill head 22. The adapter-thread 36 combs with a drill head-thread 48 of the drill head 22, so that a tapered shaft 50 of the drill head 22 can be pulled form-lockingly connected to the tapered bore 38. In this condition, a shoulder 52 of the drill head 22 and an opposite application surface 54 of the base 32 are flush against each other and ensure a stiff connection.

Between a front face 56 of the tapered shaft 50 and a supporting surface 58 of the base 32, a ring element 60 segmented depending on the number of tappets 42 is placed. This ring element 60 fills the otherwise present undercut im the area between tapered shaft 50 and base 32, so that a continuous transfer results between the drill head-channel 46 and the central channel 44. This prevents chip accumulation.

FIG. 6a shows schematically how cooling lubricant 62 is supplied to a space 64 between workpiece 30 and drill head 22. This cooling lubricant 62 is removed in blind hole processing together with the resulting chips through the drill head-channel 46, which is open towards the front face of the drill head 22, and thus enters channel 44 (FIG. 2).

From there, the cooling lubricant enters a bore 66 in the tool holder and is supplied to a cooling lubricant treatment system from there.

FIG. 3 shows a cross-section A-A pursuant to FIG. 2 on the left and a cross-section B-B pursuant to FIG. 2 on the right. The left partial figure shows that the adapter thread 36 and the drill head-thread 48 are each interrupted, so that at least three, and in this case four, angle positions of the union nut 34 relative to the drill head 22 exist, in which the drill head and adapter can be moved axially against each other. This way, turning the union nut by less than 90°, in this case less than 80°, specifically 70°, is enough to connect the adapter to the drill head.

In the right partial figure, recesses 67.1, 67.2, 67.3, 67.4 are shown, which are introduced into the union nut 34, so that a gripper described above can positive-lockingly, i.e. form-lockingly, interlock with them.

FIG. 4 shows the adapter 20, which instead of the ring element 60 (cf. FIG. 2) comprises a holder of a central pressurised fluid line 68. This pressurised fluid line 68 is placed in the central channel 44 and transfers a fluid pressure p from the hydraulic fluids supply unit 24a (see FIG. 1) to a skiving tool 70 in operation, which is connected to adapter 20 instead of the drill head in FIG. 3.

The skiving tool 70 comprises an input opening 72 that is formed to connect to the pressurised fluid line 68 and that is formed at a pressure channel 64. The pressure channel 64 leads to a control cylinder not drawn in FIG. 3, by which the skiving knives, also not illustrated, can be retracted and/or extended. This way, it is possible to retract the skiving knives after use, so that the inner surface of the workpiece produced when moving in a processing direction B cannot be damaged by the skiving knives. Therefore, it is possible to produce a stepped bore with the adapter shown in FIG. 3 to produce a stepped bore if no blind bore is present.

FIG. 4 further shows that the adapter 20 has an output valve 76 on the output side that comprises an output valve body 78. This closes the opening, preventing escaping of pressure fluid when disconnecting the skiving tool 70. The pressure fluid may be hydraulic oil, which has the benefit that the skiving tool can be particularly clean. Alternatively, it may also be a cooling lubricant, so that no separate hydraulic fluid needs to be provided in addition to the cooling lubricant.

FIG. 5 shows an alternative embodiment that has no output valve 76. This embodiment is used, e.g., for machine tools in the form of CNC-lathes. The pressurised fluid line 68 is connected to the cooling lubricant supply unit 24 of the CNC-lathe, so that cooling lubricant can be routed to the tools or the drill head.

FIG. 6 shows a method according to the invention for producing a blind bore on a deep-drilling machine. It is clear that the drill head 22 is moved forward in machining direction B. The cooling lubricant 62 is pressed into the space 64 between the drill head 22 and a workpiece inside 80 and drains through the drill head channel counter to the machining direction B. After drilling out, the drill head is removed from the workpiece counter to the machining direction B. The skiving tool 70 is then connected to the adapter in the above manner and the workpiece inside is skived. Subsequently, a rolling tool 82 shown in FIG. 5c is connected to the adapter and the workpiece inside 80 is rolled smooth.

FIG. 7 shows processing of a stepped bore on a CNC-lathe, where the cooling lubricant cannot be supplied as shown in FIG. 5 in the space between tool and workpiece inside. Partial FIG. 7a shows that the drill head 22 comprises a drill head cooling lubricant line 84 that is connected to the drill head-channel 46, so that cooling lubricant from the pressurised fluid line 68 (cf. FIG. 3 or 4) can be discharged into the space 64. The cooling lubricant 62 with chips drains in the machining direction B.

FIG. 7b shows an alternative skiving tool 70, which comprises a skiving tool-cooling lubricant line 68 that also is connected to a channel 88, in turn connected to the pressurised fluid line 68 (cf. FIGS. 3, 4).

FIG. 7c shows an alternative rolling tool 82 with a rolling tool-cooling lubricant line 90, which is also connected to a channel 92, which in turn is connected to the pressurised fluid line 68 in operation.

FIG. 8 shows a gripper unit 94, comprising a gripper 96 by which the drill head 22, skiving tool 70 and rolling tool 82 can be held. The gripper 96 comprises at least one handle, in this case two handles 98.1, 98.2, formed to interlock with the recesses 67.1, 67.2 (cf. FIG. 3).

The gripper unit 94 can be positioned automatically. For example, it is attached to a tool changer of the machine tool, so that the gripper 96 can be positioned automatically by a machine control of the machine tool that is not illustrated. For this purpose, it is beneficial if the machine tool is formed to bring the workpiece holder to a specifiable angle position. In other words, it is beneficial if the machine tool comprises an angle encoder based on which the angle position of the tool holder can be specified relative to the machine frame. However, it is also possible that the gripper unit is attached relative to the machine bed and comprises a dedicated control unit by which the gripper 96 can be positioned. In this case, it is beneficial if the machine control with the control of the gripper unit is at the bottom so that a programme running on the machine control can also position the gripper.

FIG. 9 shows a view B-B pursuant to FIG. 8. It is shown that the gripper 96 comprises at least one gripper arm, in this case two gripper arms 100.1, 100.2, which can be opened and closed with a drive 102, in this case formed by a hydraulic or pneumatic cylinder, to grip the tool, i.e. the drill head 22, skiving tool 70 or rolling tool 82. The gripper arms 100 (references without counting suffix always designate all corresponding objects) are attached to a holder 104 that can be put into a specifiable position with another drive 106.

FIG. 10 shows a view C-C pursuant to FIG. 8. It is clear that the drive 106, which is formed as a hydraulic of pneumatic cylinder in this case, is placed so that a C-wrench 105 attached to the holder 104 can be turned so that the handles 98.1, 98.2 installed at the C-wrench 105 will perform a circle around a rotating axis D of the tool holder 16 and thus the adapter 20 and the respective connected tool.

Since the respective tool 22, 70, 82 as shown in FIG. 9, is fastened by the at least one gripper arm, the at least one handle 98 can also turn the union nut 34 (cf. FIG. 2) relative to the tool and thus also to the base 32 and thus loosen the connection between the tool and the adapter

FIG. 11 shows the view A-A pursuant to FIG. 8. It shows that a C-wrench 105, on which the handles 98 are attached (cf. FIG. 10), is attached to the holder 104 by rollers 108.1, . . . , 108.7. By actuation of the drive 106, the rollers 108 will roll off against the holder 104, so that the C-wrench 105 will move around the rotating axis D.

A method according to the invention is performed by initially clamping a workpiece in the form of a cylinder blank on the machine tool 10. Then the workpiece inside 80 is drilled out with the drill head 22. Subsequently, the drilling head is released from the adapter by positioning the gripper unit automatically as described above and loosening the connection between the union nut and the drilling head 22 by turning the gripper 96.

Then the drill head is automatically put down by the gripper unit, e.g. in a tool magazine, and the skiving tool is collected and automatically connected to the adapter, with the connection connecting the pressurised fluid line 68 (cf. FIG. 3) and the pressure channel 74 of the skiving tool. Subsequently, the workpiece inside is rolled smooth by the burnishing tool. Subsequently, the skiving tool is automatically loosened from the adapter and the burnishing tool automatically connected to the adapter. In a following work step, the workpiece inside is rolled smoothly.

FIG. 12 shows the use of the adapter set when producing stepped bores (upper partial figures) and blind bores (lower partial figures) on deep-drilling machines. It is not illustrated that the skiving tool 70 (FIG. 12d), the rolling tool 82 (FIG. 12e) and the combined skiving-rolling tool 110 pursuant to FIG. 12b each can be actuated by pressure fluids. The rolls of the rolling tools 82 can be retracted and/or extended by changing the fluid pressure of the pressure fluid. The same applies to the skiving knives of the skiving tool 82. It is shown that the tool set for deep-drilling machines and CNC-lathes permits automated processing of cylinders with stages and blind holes if required.

Reference list

| | |
|---|---|
| 10 | Machine tool |
| 12 | Machine bed |
| 14 | Workpiece holder |
| 16 | Tool holder |
| 18 | Rotary drive |
| 74 | Pressure channel |
| 20 | Adapter |
| 22 | Drill head |
| 24 | Cooling lubricant supply unit |
| 24a | Hydraulic fluids supply unit |
| 26 | Cooling lubricant supply line |
| 28 | Inner wall |
| 30 | Workpiece |
| 32 | Base |
| 34 | Union nut |
| 36 | Adapter-thread |
| 38 | Tapered bore |
| 40 | Drive side |
| 42 | Anti-rotation device |
| 44 | Channel |
| 46 | Drill head-channel |
| 48 | Drill head-thread |
| 50 | Tapered shaft |
| 52 | Shoulder |
| 54 | Application surface |
| 56 | Supporting surface |
| 58 | Supporting surface |
| 60 | Ring element |
| 62 | Cooling lubricant |
| 64 | Space |
| 66 | Bore |
| 67 | Recess |
| 68 | Compressed air line |
| 70 | Skiving tool |
| 72 | Input opening |
| 74 | Pressure channel |
| 76 | Output valve |
| 78 | Output valve body |
| 80 | Workpiece inside |
| 82 | Rolling tool |
| 84 | Drill head-cooling lubricant line |
| 86 | Skiving tool cooling lubricant line |
| 88 | Channel |
| 90 | Rolling tool-cooling lubricant line |
| 92 | Channel |
| 94 | Gripper unit |
| 96 | Gripper |
| 98 | Handle |
| 100 | Gripper arm |
| 102 | Drive |
| 104 | Holder |
| 105 | C-wrench |
| 106 | Drive |
| 108 | Roll |
| 110 | Combined tool |
| L | Longitudinal axis |
| p | Fluid pressure |
| B | Machining direction |
| D | Rotating axis |

1. A material-removing machine tool, comprising:
(a) a workpiece holder to hold a workpiece;
(b) a tool holder;
(c) a rotary drive by which the tool holder can be turned relative to the workpiece holder;
(d) an adapter, comprising
a base connected to the tool holder torque-proofly,
an input side facing towards the tool holder and an output side facing away from the tool holder,
an anti-rotation device to prevent twisting the drill head and adapter relative to each other, and
a central, continuous channel, through which chips can be removed counter to a machining direction of the drill head;
(e) a drill head, connected to the adapter torque-proofly,
wherein the drill head
has a drill head-thread, and
a tapered shaft, and
wherein the adapter
(i) has a union nut, that is attached turning to the base and an adapter thread for interaction with the drill head-thread, and
(ii) a tapered bore to receive the tapered shaft.

2. The material-removing machine tool according to claim 1, further comprising:
a pressurised fluid line running through the central channel; and
drill head-cooling lubricant line,
connected to the pressurised fluid line, and
an opening at a radially outer face of the drill head so that cooling lubricant from the pressurised fluid line can be supplied to a space between the drill head and an inner wall of the workpiece.

3. The material-removing machine tool according to claim 1, further comprising an automatically controllable gripper unit, comprising a gripper that is formed for form-locking connection to the union nut, so that the connection between adapter and drill head can be automatically released and/or produced.

4. The material-removing machine tool according claim 1 wherein the union nut can be put
in a release position in which the drill head can be moved in the axial direction relative to the adapter, and
in a locking position in which the drill head is form-lockingly connected to the adapter,
and wherein
the union nut can be put from the locking position to the release position by a turn relative to the base by no more than 90°.

5. The material-removing machine tool according to claim 1 wherein
the adapter comprises a central pressurised fluid line,
which is placed in the central channel and is connected to a pressure fluid-supply unit to charge it with fluid pressure (p) on its side facing the workpiece holder, so that the fluid pressure (p) can be transmitted from the input side to the output side.

6. The material-removing machine tool according to claim 5, further comprising a skiving tool, comprising
an input opening that is placed to connect to the pressurised fluid line and
a pressure channel, connected with at least one control cylinder to actuate at least one skiving knife, and
formed so that the skiving tool can be put in and/or out of interlock by charging the pressurised fluid line with fluid pressure (p).

7. The material-removing machine tool according to claim 1 wherein the material-removing machine tool is a lathe that comprises
a cooling lubricant supply unit to discharge cooling lubricant with a pressure below 45 bar, and
a pressure increase unit that is connected to the cooling lubricant supply unit and formed to increase the pressure to at least 50 bar.

8. A tool set, comprising:
a. an adapter, that
(i) can be connected to a tool holder of a material-removing machine tool torque-proofly,
(ii) comprises an input side facing the tool holder and an output side facing away from the tool holder, and
(iii) comprises a central, continuous channel; and
b. a drill head,
wherein the central channel is formed to remove the chips and cooling lubricant contrary to a processing direction of the drill head,
wherein the adapter comprises an anti-rotation device to prevent twisting of the drill head and adapter relative to each other,
wherein the adapter comprises
(i) a union nut, which comprises an adapter-thread, and
(ii) a tapered bore,
wherein the drill head, comprises
(i) a drill head-thread for form-locking interaction with the adapter-thread, and
(iii) a tapered shaft for form-locking interaction with the tapered bore; and
c. a skiving tool that can be form-lockingly connected to the adapter instead of the drill head.

9. The tool set according to claim 8, wherein
the adapter comprises a pressurised fluid line that runs in the central channel and from an the input side to an output side,
the skiving tool comprises at least one skiving knife and one actuation device to actuate the skiving knife which can be actuated by fluid pressure (p), and
the pressurised fluid line is connected to the actuation device, so that charging of the pressurised fluid line with fluid pressure (p) permits extending and/or retracting the at least one skiving knife.

10. The tool set according to claim 8 further comprising
a burnishing tool that can be connected to the adapter form-lockingly alternatively to the drill head, a tapered shaft for form-locking connection to the tapered bore of the adapter.

11. A method to produce a cylinder with one or more of a blind bore and a stepped bore, comprising the steps:
(i) clamping of a workpiece on a machine tool as set forth in claim 1,
(ii) drilling open a workpiece inside with a drill head, connected to a tool holder with an adapters,
(iii) automatic loosening of the drill head from the adapter,
(iv) automatic connection of a skiving tool to the adapter, so that a pressure line of the adapter is connected to a pressure channel of the skiving tool,
(v) skiving the workpiece inside of the workpiece with the skiving tool, if required actuation of the at least one skiving knife of the skiving tool by application of the pressure line of the adapter with fluid pressure (p),
(vi) automatic loosening of the skiving tool and connection of a rolling tool to the adapter,
(vii) burnishing of the workpiece inside of the workpiece with the rolling tool,
(viii) with the workpiece being drilled, skived and burnished in the same clamp and
(ix) with chips from drilling open of the cylinder inner wall being removed through a central, continuous channel in the adapter contrary to a processing direction (B).

12. The machine tool according to claim 1 wherein the machine tool is a lathe.

13. The machine tool according to claim 1 wherein the machine tool is a deep drilling machine.

14. The tool set according to claim 8 wherein the skiving tool is a combined skiving burnishing tool.

15. The tool set according to claim 10 further comprising:
a rolling tool-cooling lubricant line that is formed connectable to an adapter-cooling lubricant line; and
an opening at a radial outer face of the burnishing tool, configured so that cooling lubricant from the adapter-cooling lubricant line can be supplied to a space between the burnishing tool and an inner wall of the workpiece.
